(19) United States
(12) Patent Application Publication
(10) Pub. No.: US 2012/0133745 A1
(43) Pub. Date: May 31, 2012

(54) IMAGING DEVICE, IMAGING SYSTEM, AND IMAGING METHOD

(75) Inventor: Junichi TAKIZAWA, Yokohama-shi (JP)

(73) Assignee: Samsung Electronics Co., Ltd., Suwon-si (KR)

(21) Appl. No.: 13/305,321

(22) Filed: Nov. 28, 2011

(30) Foreign Application Priority Data
Nov. 26, 2010 (JP) 263970/2010

(51) Int. Cl. H04N 13/02

(52) U.S. Cl. 348/49; 348/E13.074

(57) ABSTRACT

Provided are an imaging device, imaging system, and image method for imaging and displaying a stereoscopic image without degrading the three-dimensional image. A control operation of the imaging device synchronizes driving timing of the shutter unit with display conversion timing of the display device based on the display conversion signal received by a receiver, and separately images the left eye image and the right eye image in the imaging unit.

### PRIORITY

This application claims priority under 35 U.S.C. §119(a) to a Korean Patent Application filed in the Japanese Patent Office on Nov. 26, 2010 and assigned Serial No. JP263970/2010, the contents of which are incorporated herein by reference.

### BACKGROUND OF THE INVENTION

1. Field of the Invention

The present invention relates generally to an imaging device, an imaging system, and an imaging method.

2. Description of the Related Art

A digital camera for photographing an image of a subject, such as persons or a landscape, using an imaging element is known in the art as an imaging device. There exists a need in the art for such an imaging device to image a display screen of a display device such as a television using the foregoing imaging device.

To this end, a display device for displaying a stereoscopic image has been developed, and an example of the same is disclosed in Japanese application publication no. 2010-093740 to Hasegawa et al. The display device displays a stereoscopic image by alternately displaying a left eye image and a right eye image corresponding to a binocular parallax for each frame, in a device known as a frame sequential type display device. The user may view a left eye image and a right eye image displayed on the display screen using dedicated spectacles with a shutter to recognize a displayed stereoscopic image.

However, the prior art is flawed in that to this point, there has been a lack of an imaging device for imaging a stereoscopic image displayed on the display screen. Thus, when imaging the display screen displaying a stereoscopic image by the imaging device, a left eye image and a right eye image have been combined with each other in a manner that has produced a degraded photographed image.

### SUMMARY OF THE INVENTION

Accordingly, an aspect of the present invention is to solve the above-mentioned problems occurring in the prior art, and to provide a newly improved imaging device, imaging system, and image method for imaging a stereoscopic image displayed on a display screen of a display device without degrading the stereoscopic image.

In accordance with an aspect of the present invention, there is provided an imaging device, including an imaging unit for imaging a display screen when a display device alternately displays a left eye image and a right eye image corresponding to a binocular parallax for each frame, a receiver for receiving a display conversion signal of the left eye image and the right eye image, a shutter unit for controlling exposure to the imaging unit, and a controller for performing a control operation to synchronize driving timing of the shutter unit with display conversion timing of the display device based on the display conversion signal received by the receiver, and separately imaging the left eye image and the right eye image in the imaging unit.

In accordance with another aspect of the present invention, there is provided an imaging system, including a display device for alternately displaying a left eye image and a right eye image corresponding to a binocular parallax for each frame, and an imaging device including an imaging unit for imaging the display screen, wherein the display device includes a transmitter for transmitting a display conversion signal of the left eye image and the right eye image, and the imaging device includes a receiver for receiving a display conversion signal of the left eye image and the right eye image, a shutter unit for controlling exposure to the imaging unit, and a controller for performing a control operation to synchronize driving timing of the shutter unit with display conversion timing of the display device based on the display conversion signal received by the receiver, and separately imaging the left eye image and the right eye image in the imaging unit.

In accordance with a further aspect of the present invention, there is provided an imaging method, including receiving a display conversion signal of the left eye image and the right eye image corresponding to a binocular parallax from a display device by an imaging device when the display device alternately displays on a display screen for each frame, and performing a control operation to synchronize shutter timing of the imaging device with display conversion timing of the display device based on the received display conversion signal, and separately imaging the left eye image and the right eye image by the imaging device.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a display system according to an embodiment of the present invention;

FIG. 2 illustrates the relationship of a display of a left eye image and a right eye image and a shutter operation of shutter attached spectacles;

FIG. 3 illustrates an internal configuration of an imaging device according to an embodiment of the present invention;

FIG. 4 illustrates a state in which a left eye image and a right eye image are combined with each other and the combined image is photographed according to an embodiment of the present invention;

FIG. 5 illustrates an operation of an imaging device when photographing a three-dimensional image displayed on a display screen as a still image according to an embodiment of the present invention; and

FIG. 6 illustrates an operation of an imaging device when photographing a three-dimensional image displayed on a display screen as a moving image according to an embodiment of the present invention.

### DETAILED DESCRIPTION OF EMBODIMENTS OF THE PRESENT INVENTION

Hereinafter, embodiments of the present invention will be described with reference to the accompanying drawings. In the following description, the same elements will be designated by the same reference numerals although they are shown in different drawings. A detailed description of a generally known function and structure of the present invention will be omitted for the sake of clarity and conciseness.

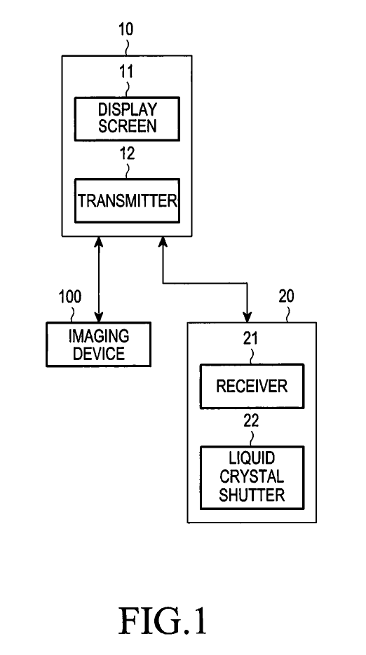

FIG. 1 illustrates a display system 1 according to an embodiment of the present invention.

The display system 1 can display a three-dimensional image as well as a two-dimensional image. The display system 1, which includes a display device 10, shutter attached spectacles 20, and an imaging device 100, enables a user to recognize a displayed three-dimensional image and image the displayed three-dimensional image without degrading image quality.

The display device 10 is a display element, and includes a display screen 11 and a transmitter 12. When the display device 10 displays the three-dimensional image, a left eye image and a right eye image corresponding to a binocular parallax may be alternately displayed on the display screen 11. The transmitter 12 transmits a display conversion signal of a left eye image and a right eye image configuring a three-dimensional image to the shutter attached spectacles 20 or the imaging device 100. The display conversion signal is generated in the display device 10, and is transmitted in wireless communication such as infrared communication.

The shutter attached spectacles 20 enable a user to recognize a three-dimensional image displayed on a display screen 11 of the display device 10. The shutter attached spectacles 20 have a receiver 21 and a liquid crystal shutter 22. The receiver 21 receives the display conversion signal provided from the transmitter 12 of the display device 10. The liquid crystal shutter 22 has two openable liquid crystal shutters, and an opening/closing operation of the two liquid crystal shutters may be controlled based on the display conversion signal received by the receiver 21. In detail, the opening/closing operation of the two liquid crystal shutters is controlled such that conversion timing of the two liquid crystal shutter synchronizes with display conversion timing of a display screen.

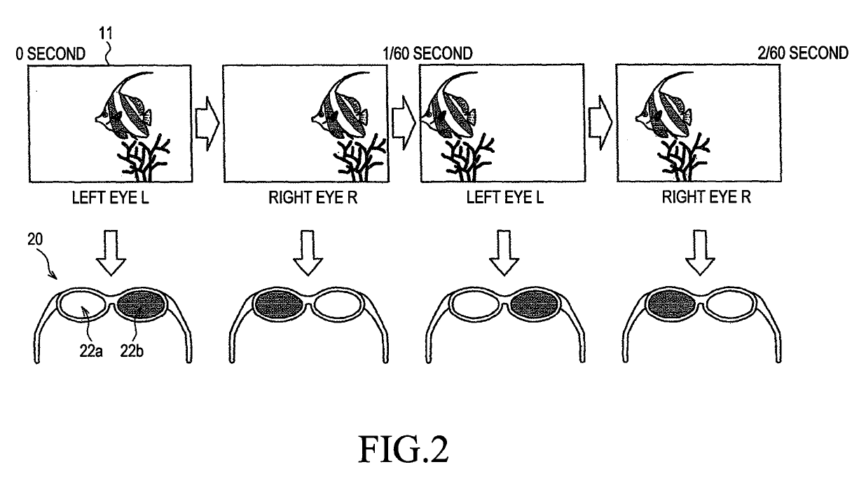

FIG. 2 illustrates the relationship between a display of a left eye image and a right eye image and a shutter operation of shutter attached spectacles 20. A left eye image L and a right eye image R are alternately displayed in FIG. 2. Two liquid crystal shutters 22a and 22b are opened/closed according to display of the left eye image L and the right eye image R. For example, when a left eye image of a liquid crystal shutter of reference numeral 22a is displayed, the liquid crystal shutter 22a is opened. When a right eye image of a liquid crystal shutter of reference numeral 22b is displayed, the liquid crystal shutter 22b is opened. The user viewing a display screen 11 while wearing the shutter attached spectacles 20 may control opening/closing operation of the two liquid crystal shutters 22a and 22b to recognize a three-dimensional image.

The imaging device 100 images a two-dimensional image or a three-dimensional image displayed on the display screen 11, and may communicate with the display device 10 in an infrared communication scheme. The imaging device 100 images the three-dimensional image with a left eye image and a right eye image being separated based on the display conversion signal provided from the transmitter 12. A detailed configuration of the imaging device 100 will be described below.

In the foregoing embodiment, a display conversion signal to be transmitted to the image device 100 is identical with a display conversion signal to be transmitted to the shutter attached spectacles 20. However, the present invention is not limited thereto, and the display conversion signal to be transmitted to the image device 100 may differ from the display conversion signal to be transmitted to the shutter attached spectacles 20. However, when the display conversion signal to be transmitted to the image device 100 is identical with the display conversion signal to be transmitted to the shutter attached spectacles 20, it is unnecessary for the display device 10 to generate different signals. Based on this, the device may be simplified.

Further, it is assumed that the display system 100 includes the shutter attached spectacles 20. However, the present invention is not limited thereto, and the display system 1 may not include the shutter attached spectacles 20.

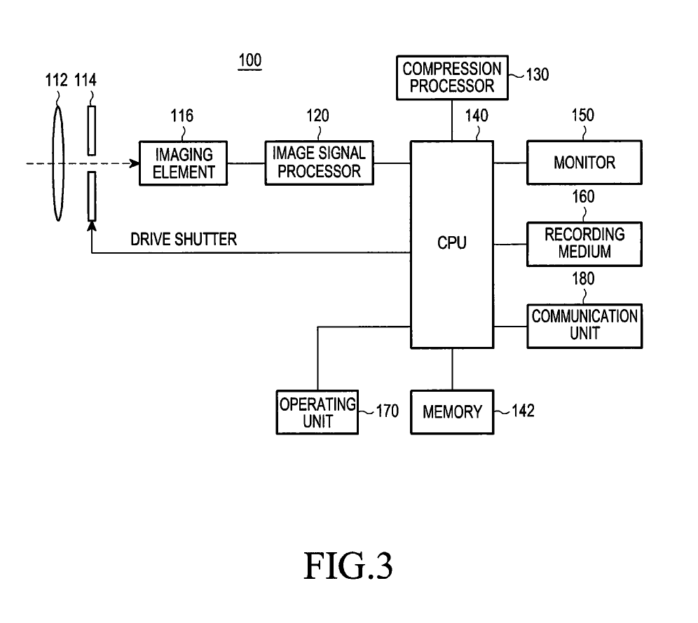

FIG. 3 illustrates an internal configuration of an imaging device 100 according to an embodiment of the present invention.

For example, the imaging device 100 is a digital camera capable of photographing a still image or a video camera capable of photographing a moving image. The digital camera may have a configuration that photographs both of a still image and a moving image.

As shown in FIG. 3, the imaging device 100 includes a lens 112, a shutter 114 being an example of a shutter unit, an imaging element 116 being an example of an imaging unit, an image signal processor 120, a compression processor 130, a Central Processing Unit (CPU) 140 being an example of a controller, a memory 142, a monitor 150, a recording medium 160 being an example of a storage unit, an operating unit 170, and a communication unit 180 being an example of a receiver.

The lens 112 is an optical system for forming an image of external optical information on an imaging element 116, and allows the light from a subject to transmit through the lens 112 to the imaging element. For example, the lens 112 includes a zoom lens, an iris, and a focusing lens that are not shown. The zoom lens modifies a focusing lens to change an angle of view. The iris controls an amount of transmitted light. The focusing lens moves in an optical direction to focus an image of a subject at an image surface of the imaging element 116.

The shutter 114 controls exposure of the imaging element 116. An example of the shutter 114 is a mechanical shutter. The shutter 114 blocks light at the non-imaging time to transfer the light to the imaging element 116 at only the photographing time. Further, the shutter 114 is not limited to a mechanical shutter, and may also be configured by an electronic shutter. Drive timing of the shutter 114 is controlled to synchronize with display conversion timing of a display screen 11 based on a display conversion signal received from the display device 10.

The imaging element 116 is an example of a photoelectric transformation element. The imaging element 116 is configured by a plurality of elements for transforming optical information transmitted and input through the lens 112 into an electric signal. Each element generates an electric signal according to an amount of received light. A Charge Coupled Device (CCD) image sensor, or a Complementary Metal Oxide Semiconductor (CMOS) image sensor is applicable as the imaging element 116.

The imaging element 116 may further include a Correlated Double Sampling/Amplifier (CDS/AMP) and an Analog/Digital (A/D) converter. The CDS/AMP eliminates reset and amplifier noise included in an electric signal output from the imaging element 116, and amplifies an electric signal. The A/D converter converts an electric signal output from the CDS/AMP into a digital signal, which it outputs to the image signal processor 120.

The image signal processor 120 controls gain correction of light amount or white balance with respect to raw image data obtained from the imaging element 116. The image signal processor 120 performs pixel defect, black level, and shading corrections of the imaging element 116.

The compression processor 130 compresses an image in which gain correction of light amount is performed or white balance is controlled into image data of a suitable format. For example, the compression processor 130 performs compression coding processing in a coding scheme of a still image such as Joint Photographic Experts Group (JPEG) standard. For example, the compression processor 130 performs coding processing in an Motion Picture Experts Group (MPEG) format to generate stream data having a plurality of image frames collected as one file.

The CPU 140 functions as an arithmetic processor and a controller by a program, and controls processing of respective structural elements included in the imaging device 100. For example, the CPU 140 controls an opening/closing operation (drive timing) of the shutter 114. The memory 142 stores programs or various data, such as image data, executed by the CPU 140.

The monitor 150 displays an image, such as a live view display read from the memory 142 before photographing, various setting screens of the imaging device 100, or imaged and recorded images. Examples of the monitor 150 are a liquid display device, an organic electroluminescence display, and an Organic Light Emitting Diode (OLED).

In this embodiment, the recording medium is a memory card, and records photographed image data. The recording medium 160 is attachably/detachably configured to and from the imaging device 100. However, the recording medium 160 is not limited to the memory card, and may be configured by an optical disk such as a Compact Disc (CD), Digital Video Disc (DVD, a blu-ray disc, or magneto-optical disk.

The operating unit 170 operates the imaging device 100 or performs various settings at a photographing time. The operating unit 170 includes a power button, a selection button for selecting a photographing mode, a shutter button for starting a photographing operation of a subject, and a cross key, all of which are not shown.

The communication unit 180 wirelessly communicates with the display unit 10, such as by infrared communication. The communication unit 180 receives a display conversion signal provided from the transmitter 12. A communication scheme of the communication unit 180 is not limited to wireless communication. The communication unit 180 may be configured to communicate with the display unit 10 through a cable in a wired communication scheme.

When the imaging device 100 according to this embodiment photographs a display screen 11 displaying a three-dimensional image, it images the three-dimensional image with a left eye image and a right eye image being separated based on a display conversion signal provided from the transmitter 12. Specifically, the imaging device 100 synchronizes drive timing of the shutter 114 with display conversion timing of the left eye image and the right eye image based on the received display conversion signal, and the imaging element 116 of the imaging device 100 images the thee-dimensional image with the left eye image and the right eye image being separated.

Accordingly, a degraded image in a combined state of the left eye image and the right eye image is prevented from being photographed. When a left eye image and a right eye image imaged combined to produce a three-dimensional image are used to divide the three-dimensional image into a left eye image and a right eye image, a high-quality image is produced.

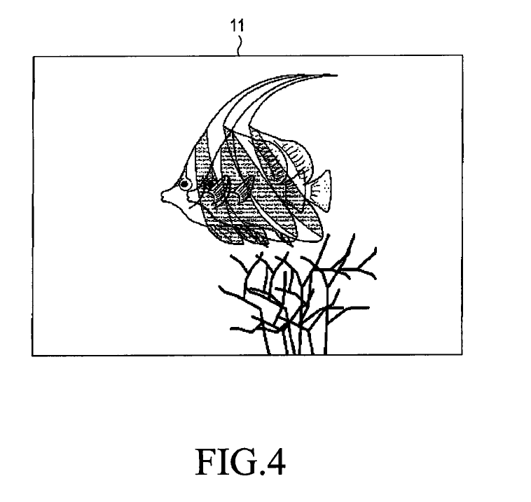

FIG. 4 illustrates a state in which a left eye image and a right eye image are combined with each other and the combined image is photographed according to an embodiment of the present invention.

The following is a detailed operation of the photographing device 100 imaging a three-dimensional image with a left eye image and a right eye image being separated when the three-dimensional image is displayed. Further, the imaging device 100 according to this embodiment may photograph a still image or a moving image. Accordingly, after an operation of the imaging device 100 is described when photographing a three-dimensional image as a still image, an operation of the photographing device 100 when photographing the three-dimensional image as a moving image will be described.

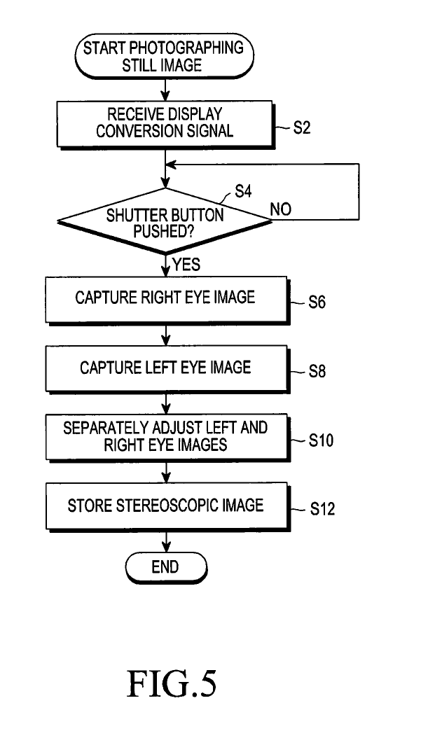

FIG. 5 illustrates an operation of an imaging device 100 when photographing a three-dimensional image displayed on a display screen 11 as a still image according to an embodiment of the present invention.

In the flowchart of FIG. 5, a display device 10 starts to alternately display a left eye image and a right eye image for each frame from a displayed time of a three-dimensional image. Further, it is assumed that a transmitter 12 of the display device 10 transmits a display conversion signal according to display of a three-dimensional image. The display conversion signal is received by shutter attached spectacles 20 and a photographing device 100.

A communication unit 180 receives a display conversion signal provided from a transmitter 12 (step S2), and continuously receives the display conversion signal while communicating with a display device 10.

A CPU 140 determines whether a shutter button of an operating unit 170 is pushed to photograph a still image (step S4). When the shutter button is pushed by a user (YES in step S4), a CPU 140 controls driving of a shutter 114, and images one (hereinafter right eye image) of a pair of a left eye image and a right eye image in an imaging element 116 (step S6).

The CPU 140 controls drive timing of a shutter 114 synchronizing with display conversion timing of a left eye image and a right eye image. At the display conversion time from a left eye image to a right eye image immediately after the shutter button is pushed, the imaging element 116 images only a right eye image displayed on the display screen 11 so that the shutter 114 is in an open state.

Subsequently, at the display conversion time from the right eye image to the left eye image, the imaging element 116 images only a left eye image displayed on the display screen 11 (step S8). If the shutter button is pushed, because the left eye image and the right eye image are separately imaged, the CPU 140 may avoid a combined state of the left eye image and the right eye image.

An image processor 120 separately adjusts the imaged left and right eye images (step S10). For example, when there is a difference between a left eye image and a right eye image by photographing conditions, the image processor 120 adjusts two images. A method for multiplying a gain according to an energy rate of an entire image screen is applicable as the adjust method, and an average of a range of 30% is used at a center of a plane that does not comprise an entire screen. Thus, a processing time may be shortened.

The CPU 140 separates a three-dimensional image displayed on the display screen 11 into a left eye image and a right eye image, and stores the separated left and right eye images in a recording medium 160 (step S12). As the three-dimensional image are separated into the left eye image and the right eye image, and the separated left and right eye images are stored, any degradation of the image quality played as the three-dimensional image is virtually eliminated. Because one side of the separated and stored left and right eye images may be used as a two-dimensional image, a use range of the imaged three-dimensional image may be extended.

As the left eye image and the right eye image are separately stored, photographing still image is terminated. Step S10 of controlling the separated and imaged left and right eye images may be realized by storing the left eye image and the right eye image in the recording medium 160 and then the left and right eye images may be independently performed.

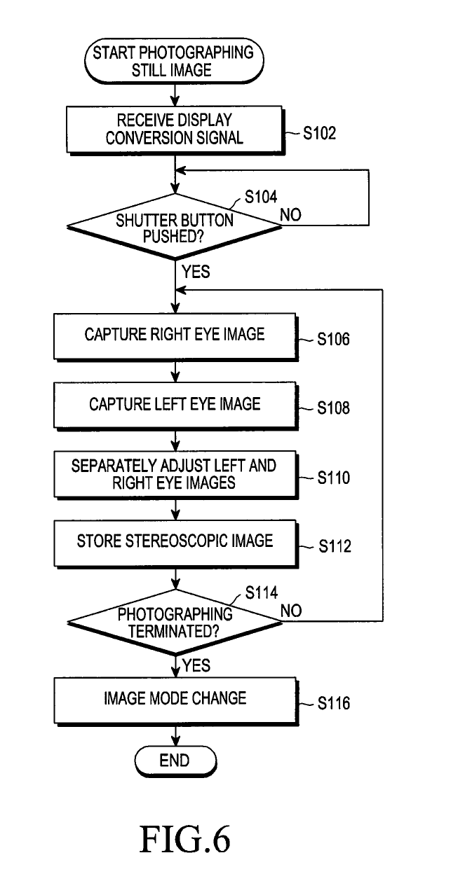

FIG. 6 illustrates an operation of an imaging device 100 when photographing a three-dimensional image displayed on a display screen 11 as a still image according to an embodiment of the present invention.

In the flowchart of FIG. 6, a display device 10 starts to alternately display a left eye image and a right eye image for each frame from a displayed time of a three-dimensional image. Further, it is assumed that a transmitter 12 of the display device 10 transmits a display conversion signal according to display of a three-dimensional image.

A communication unit 180 receives a display conversion signal provided from a transmitter 12 (step S102). The CPU 140 determines whether a shutter button of an operating unit 170 is pushed to photograph a moving image (step S104). When a shutter button is pushed by the user (YES in step S104), the CPU 140 controls drive timing of a shutter 114, and images a three-dimensional image with a left eye image and a right eye image in a separated manner in the imaging element 116 (steps S106 and S108). Accordingly, when photographing the moving image, the CPU 140 images a three-dimensional image displayed on the display device 10 with a left eye image and a right eye image being separated.

As steps S106 to S112 of FIG. 6 are identical to steps S6 to S12 of FIG. 5, a detailed description thereof is omitted.

If the left and right eye images are separately stored in the recording medium 160, the CPU 140 determines whether to terminate photographing of a moving image (step S114), based on a termination operation of a user. Termination of photographing a moving image is achieved when a display of a three-dimensional image by the display device 10 is terminated

When photographing the moving image continues (YES in step S114), steps S106 to S112 are repeated. That is, when photographing the moving image, the imaging device 100 separately and continuously images the left eye image and the right eye image. When display of the three-dimensional image is terminated to determinate photographing a moving image (YES in step S114), the CPU 140 changes a three-dimensional imaging mode separately imaging a left eye image and a right eye image to a two-dimensional imaging mode imaging a single image (step S116). Accordingly, for a general next imaging, the user does not need an operation converting a mode.

As illustrated above, when photographing a display screen 11 displaying a three-dimensional image, an imaging device 100 separately images a three-dimensional image with a left eye image and a right eye image being separated to prevent a degraded image due to a combination of the left eye image and the right eye image from being photographed.

Further, a left eye image and a right eye image are separately stored in a recording medium 160. The left eye image and the right eye image are extracted from the photographed three-dimensional image to be used as a two-dimensional image. Because driving of a shutter 14 is controlled using a display conversion signal transmitted to the shutter attached spectacles 20, it is unnecessary to change a configuration of the display device 10, resulting in a more efficient system than the conventional system.

The foregoing embodiment has disclosed that the display device 100 sequentially converts a left eye image and a right eye image. However, the present invention is not limited thereto. For example, while display is changed from a left (right) image to a right (left) image, the display device 10 may be configured to display a black image. In this case, the left eye image and the right eye image are separately imaged based on a display conversion signal.

While the invention has been shown and described with reference to certain embodiments thereof, it will be understood by those skilled in the art that various changes in form and details may be made therein without departing from the spirit and scope of the invention as defined by the appended claims.

Further, in the foregoing embodiment, the digital camera has been described as an example of the imaging device. However, the present invention is not limited thereto. For example, the imaging device may be configured by a portable phone, a Personal Digital Assistant (PDA), a game machine, an electronic organizer, and a notebook computer.

The foregoing has disclosed that the imaging device receives a signal in an infrared communication scheme; however, the present invention is not limited thereto. For example, the imaging device may have a configuration using another near distance wireless communication scheme such as Bluetooth®.

A series of processes of the foregoing embodiment may be executed by a dedicated hardware or software (application). When the series of processes are performed by software, a program may be executed in a general or dedicated computer to implement the series of processes.

Moreover, in the embodiment described above, the display device alternately displays a left eye image and a right eye image constituting a stereoscopic image in a frame sequential type. However, the present invention is not limited thereto. For example, the display device may operate to alternately display a plurality of different images (e.g., first image and second image) toward users of different time points. For example, the first image is viewed by only a first user, and the second image is viewed by one other user. In this case also, the imaging device may take a plurality of different images separately displayed on the display device.

Moreover, the present invention has disclosed that respective steps included in the foregoing flowcharts are sequentially performed processes in a described order. However, the present invention is not limited thereto. The respective steps may be implemented by a manner that is not always processed but is performed in parallel or independently. In addition, a performing order of sequentially processed steps may be suitably changed in some cases.

What is claimed is:

1. An imaging device comprising:
an imaging unit for imaging a display screen when a display device alternately displays a left eye image and a right eye image corresponding to a binocular parallax for each frame;
a receiver for receiving a display conversion signal of the left eye image and the right eye image;
a shutter unit for controlling exposure to the imaging unit; and
a controller for performing a control operation to synchronize driving timing of the shutter unit with display conversion timing of the display device based on the display conversion signal received by the receiver, and separately imaging the left eye image and the right eye image in the imaging unit.

2. The imaging device of claim 1, further comprising a single-eye lens, wherein the imaging unit separately images the left eye image and the right eye image displayed on the display screen through the single-eye lens.

3. The imaging device of claim 1, wherein the controller selectively performs one of a three-dimensional imaging mode for imaging both of the left eye image and the right eye image and a two-dimensional imaging mode for imaging a single image, and the controller changes the imaging device from the three-dimensional imaging mode to the two-dimensional imaging mode when display by the display device is terminated.

4. The imaging device of claim 1, further comprising a memory for separately storing the left eye image and the right eye image.

5. An imaging system comprising:
a display device for alternately displaying a left eye image and a right eye image corresponding to a binocular parallax for each frame; and
an imaging device including an imaging unit for imaging the display screen,
wherein the display device comprises a transmitter for transmitting a display conversion signal of the left eye image and the right eye image, and
the imaging device comprises:
a receiver for receiving a display conversion signal of the left eye image and the right eye image;
a shutter unit for controlling exposure to the imaging unit; and
a controller for performing a control operation to synchronize driving timing of the shutter unit with display conversion timing of the display device based on the display conversion signal received by the receiver, and separately imaging the left eye image and the right eye image in the imaging unit.

6. An imaging method comprising:
receiving a display conversion signal of left eye image and right eye image corresponding to a binocular parallax from a display device by an imaging device when the display device alternately displays the images on a display screen for each frame; and
performing a control operation to synchronize shutter timing of the imaging device with display conversion timing of the display device based on the received display conversion signal, and separately imaging the left eye image and the right eye image by the imaging device.

7. The method of claim 6, further comprising separately storing the left eye image and the right eye image imaged by the imaging device in a memory.

8. The method of claim 7, wherein a two-dimensional imaging mode is performed when display of the left eye image and the right eye image corresponding to a binocular parallax by the display device is terminated.
